(19) United States
(12) Patent Application Publication
(10) Pub. No.: US 2017/0211717 A1
(43) Pub. Date: Jul. 27, 2017

(54) MAGNETIC METERING VALVE AND METHOD OF OPERATING THE SAME

(71) Applicant: MECANIQUE ANALYTIQUE INC., Thetford-Mines (CA)

(72) Inventor: Yves GAMACHE, Adstock, Quebec (CA)

(21) Appl. No.: 15/301,560

(22) PCT Filed: Apr. 1, 2015
(86) PCT No.: PCT/CA2015/050263

§ 371 Date: Oct. 3, 2016

Related U.S. Application Data
(60) Provisional application No. 61/975,266, filed on Apr. 4, 2014.

(51) Int. Cl. F16K 31/06; F16K 1/52

(52) U.S. Cl. CPC F16K 31/0658; F16K 1/52; F16K 31/0679

(57) ABSTRACT

A magnetic metering valve is provided. The valve includes a body assembly, first and second fluid passages opening into a hollow chamber within the body assembly, a first controllable source of magnetic field operable to generate a first magnetic field within the hollow chamber, and a valve assembly. The valve assembly includes first and second caps covering the ports, the caps being configured to oscillate relative to the ports in response to a change of fluid pressure in the hollow chamber, the first and second caps comprising respective first and second ferromagnetic elements to interrupt or control a flow of the fluid through the first and second ports responsive to the magnetic field in the hollow chamber. In an aspect of the invention, a method of purging the metering valve is provided. A method of operating the metering valve is also provided.

### TECHNICAL FIELD

The present invention relates to the field of metering valves, and more specifically to magnetic metering valves used in analytical systems or in medical devices.

### BACKGROUND

Operating positions for 2-port valves can either be fully closed or fully open. While it is sometimes possible to partially open a valve to any degree in between, many valves are not designed to precisely control intermediate degrees of flow. In contrast to the above, metering valves are specifically designed to regulate varying amounts of flow. Such valves are also called regulating, throttling or needle valves.

Metering valves are often prone to improper sealing, even when the valve is closed. An incomplete seal can lead to leakage which can be prejudicial or even unsafe depending on the fluid passing through the valve. Typically, existing valves include a stem which enters the valve from the valve's exterior. The stem is usually sealed using a toric joint or an O-ring. Such devices, however, often do not provide adequate sealing, making the valve prone to inboard/outboard leaking around the stem. In such cases, air can potentially enter the valve or, even worse, sample fluid can escape the valve. Metering valves are also prone to dead volume issues. Dead volume is the portion of the internal volume that is out of the flow path. Typically, fluid filling the dead volume is not readily recovered and/or may take some time before getting purged from the valve. Valve manufacturers usually try to minimize such dead volume, but in some applications even the lowest concentration of impurities is undesirable and can cause problems.

In light of the above, there is a need for an improved valve with improved sealing and/or with little to no dead volume. There is also a need for a valve which can be effectively purged and for a method of purging a valve so as to reduce or eliminate the issues related to dead volume.

### SUMMARY OF THE INVENTION

According to an aspect of the invention, a magnetic metering valve is provided. The valve includes a body assembly provided with a hollow chamber, first and second fluid passages extending in the body, a first controllable source of magnetic field operable to generate a first magnetic field in the hollow chamber and a valve assembly provided in the hollow chamber. The first and second fluid passages open as first and second ports in the hollow chamber for circulating a fluid from the first fluid passage to the second fluid passage via the hollow chamber. The valve assembly includes first and second caps associated with the respective first and second ports for interrupting or controlling the flow of fluid in the hollow chamber. The first and second caps are resiliently affixed to the body assembly such that they oscillate relative to the first and second ports. The first and second caps include respective first and second ferromagnetic elements to interrupt or control a flow of fluid through the first and second ports responsive to the magnetic field in the hollow chamber. The valve may include a controller for controlling the first controllable source of magnetic field.

In an embodiment, the body assembly includes top, middle, and bottom casings, the middle casing being disposed in between the top and bottom casings, the top casing including a cavity configured to house the first source of magnetic field, the middle casing including a recessed sidewall defining a cavity, and the bottom casing sealing the cavity in the middle casing, thereby defining the hollow chamber. A non-ferrous seal may be provided between the middle and bottom casings to seal the hollow chamber.

In an embodiment, the first and second ports open along a common sidewall of the hollow chamber.

In some embodiments, the hollow chamber includes rounded sidewalls, a uniform cross-section and/or has a shape reminiscent of a semi-ellipsoid.

In an embodiment, the first controllable source of magnetic field includes a permanent magnet.

In an embodiment, the first controllable source of magnetic field includes an electromagnet and the controller may include an electric circuit configured to adjust a flow of electric current in the electromagnet.

In an embodiment, the controller includes a Vernier-type handle or a remote-controllable actuator for controlling the position of the first controllable source of magnetic field relative to the hollow chamber.

In an embodiment, the controller is configured to adjust a distance between the first controllable source of magnetic field and the hollow chamber.

In an embodiment, the valve includes a second source of magnetic field positioned opposite the first controllable source of magnetic field and separated therefrom by the hollow chamber, the second source of magnetic field being configured to generate a second magnetic field in the hollow chamber to reinforce or counteract the first magnetic field.

In an embodiment, the second source of magnetic field is removably affixed to the body assembly.

In an embodiment, the first source of controllable magnetic field includes first and second magnetic elements, the first magnetic element being configured to operate primarily on the first ferromagnetic element and the second magnetic element being configured to operate primarily on the second ferromagnetic element.

In an embodiment, the first and second caps are configured to oscillate relative to the first and second ports in response to a change of magnetic field in the hollow chamber. Preferably, the first and second caps are configured to oscillate relative to the first and second ports in response to a change of fluid pressure in the hollow chamber.

In an embodiment, the first and second caps are resiliently affixed to the body assembly via first and second resilient elements.

In an embodiment, the first and second caps are configured to oscillate at different frequencies.

In an embodiment, the modulus of elasticity of one of the first and second resilient elements is greater than the other one of the first and second resilient elements.

In an embodiment, the first and second resilient elements respectively include first and second resilient arms operatively connected to the static body via a fastening mechanism.

In an embodiment, the first and second resilient arms have a different size. A portion of the first resilient arm disposed above the first port may be wider than a corresponding portion of the second resilient arm disposed above the second port. The portion of the first resilient element may be shaped as a foil and configured to disperse fluid entering the hollow chamber toward the second port.

In an embodiment, the first and second resilient arms are integrally formed from a single strip, with the first and second resilient elements extending in opposite directions.

In an embodiment, the strip is substantially V-shaped.

In an embodiment, the first and second resilient members include pendulum springs operatively connected to the body assembly, and may be operatively connected to a ceiling of the hollow cavity.

In an embodiment, the valve includes a guiding mechanism configured to maintain the first and second ferromagnetic elements in alignment with the first and second ports, respectively. The guiding mechanism may include guide sleeves configured to guide the first and second springs, respectively.

In an embodiment, the first and second caps include first and second cushions facing the first and second ports, respectively. The cushions may be made of a polymeric material.

In an embodiment, the first and second ports include first and second perforated port caps configured to act as contact points for the first and second cushions, respectively. The cushions may be complementary in shape to their respective perforated caps. The cushions may include protrusions while the perforated caps include complementary indentations.

In an embodiment, one of the first and second ports has an opening diameter greater than that of the other one of the first and second ports.

In an embodiment, the first and second ferromagnetic elements have different magnetic properties.

In an embodiment, one of the first and second caps is larger than the other one of the first and second caps.

In an embodiment, one of the first and second caps is heavier than the other one of the first and second caps.

In an embodiment, the valve includes at least one biasing element configured to bias at least one of the first and second caps towards their corresponding port.

The biasing element may be a spring operatively connected between the first or second cap and the body assembly.

In an embodiment, the valve includes a pressure sensor configured to measure a pressure of fluid within the hollow chamber.

According to another aspect of the invention, a method of purging impurities in a magnetic metering valve is provided. The first steps involves provided a magnetic metering valve provided with a hollow chamber, first and second fluid passages extending in the body and opening as first and second ports in the hollow chamber, and first and second caps adapted to oscillate relative to said first and second ports, the first and second caps comprising respective first and second ferromagnetic elements. Next a magnetic field is generated in the hollow chamber, acting on the first and second ferromagnetic elements, thereby moving the first and second caps away from the first and second ports. Finally, a fluid is injected in the hollow chamber through the first port, thereby changing a fluid pressure in the hollow chamber, causing an oscillation of the first and second caps relative to their respective first and second ports, and purging impurities through the second port.

In an embodiment, the method includes the step of varying the strength of the magnetic field in the hollow chamber in order to control a rate of fluid flow through the valve.

In an embodiment, the method includes the step of generating a second magnetic field in the hollow chamber to control the effect of the first magnetic field acting on the first and second ferromagnetic elements.

In an embodiment, the method includes the step of reducing the strength of the first magnetic field in order to seal the valve.

In an embodiment, the method includes the step of varying a rate of fluid flow through the first port to change the fluid pressure in the hollow chamber.

In an embodiment, generating a magnetic field in the hollow chamber includes moving a permanent magnet towards the hollow chamber.

In an embodiment, generating a magnetic field in the hollow chamber includes providing electric current to an electromagnet in proximity to the hollow chamber.

In an embodiment, the first and second caps are operated to oscillate in phase, out of phase, or at different frequencies or amplitudes.

According to an aspect of the invention, a method of operating a magnetic metering valve is provided. The method includes the steps of: a) providing a magnetic metering valve including a body assembly which includes a hollow chamber, first and second fluid passages extending in the body and opening as first and second ports in the hollow chamber, and first and second caps adapted to oscillate relative to said first and second ports, the first and second caps including respective first and second ferromagnetic elements; b) operating the first cap to define a maximum rate of fluid flow entering the valve through the first port; and c) operating the second cap to vary a rate of fluid flow exiting the valve through the second port.

In an embodiment, operating the first and second caps includes varying a strength of a magnetic field respectively acting on the first and second ferromagnetic elements, thereby causing the first and second caps to move relative to their respective first and second ports.

### BRIEF DESCRIPTION OF THE DRAWINGS

FIG. 1 is a perspective view of a magnetic metering valve, according to an embodiment.

FIG. 2 is a cross-section view of the valve of FIG. 1, taken along line 2-2.

FIG. 3 is an exploded view of the valve of FIG. 1.

FIG. 4A to 4D are cross-sectional views of the valve of FIG. 1, taken along line 2-2, showing the valve in different positions and for purging the valve, according to an embodiment.

FIG. 5 is a partial close up cross-sectional view of the valve element, according to an embodiment.

FIG. 6 is another partial close-up cross-sectional view of the valve element, according to another embodiment.

FIG. 7A is a cross-sectional view of a valve according to an alternate embodiment. FIG. 7B is a partial cross-section view of the valve of FIG. 7A, taken along line 7B-7B.

FIG. 8 is a partial cross-section view of a valve according to another alternate embodiment taken along line 7B-7B.

FIGS. 9A to 9C are cross-sectional views of a valve according to alternate embodiments.

### DETAILED DESCRIPTION OF PREFERRED EMBODIMENTS

Within the following description, similar features of the drawings have been given similar reference numerals. To preserve the clarity of the drawings, some reference numerals have been omitted when they were already identified in a preceding figure.

The implementations described below are given by way of example only and the various characteristics and particularities thereof should not be considered as being limitative of the scope of the present invention. Unless otherwise indicated, positional descriptions such as “top”, “bottom” and the like should be taken in the context of the figures and should not be considered as being limitative.

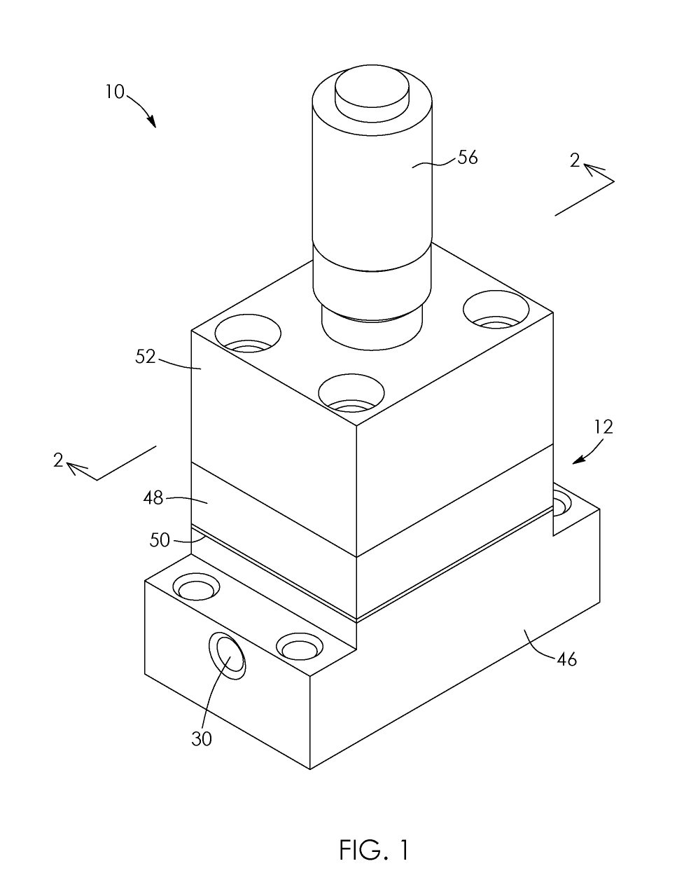

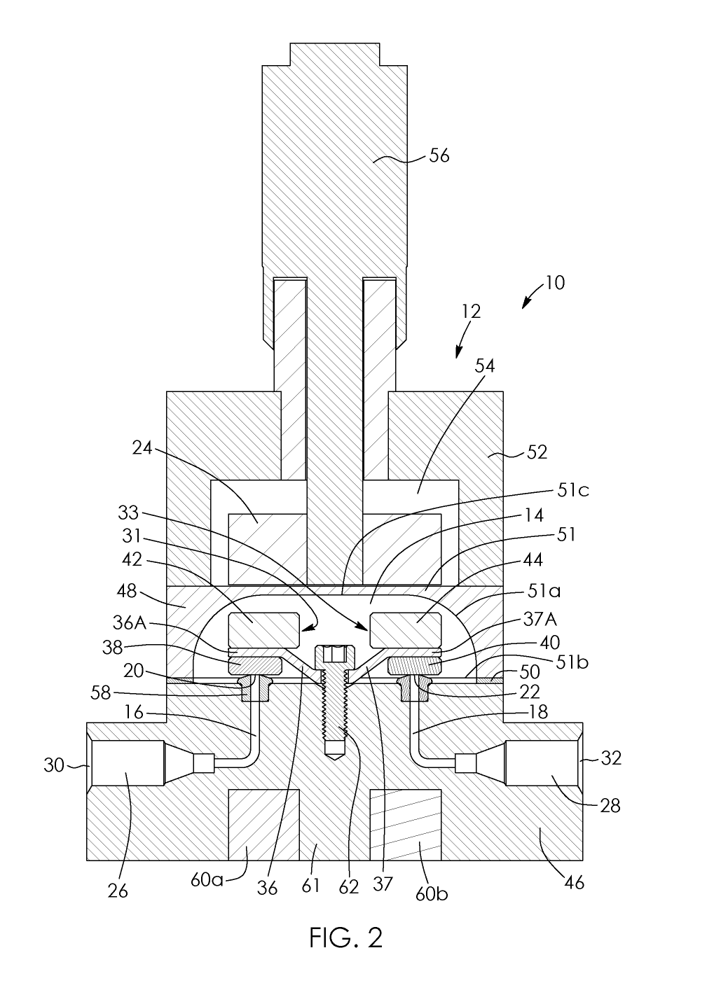

Referring to FIGS. 1, 2 and 3, a magnetic metering valve 10 is shown, according to an embodiment of the invention. The valve 10 includes a body or housing assembly 12 which has a hollow chamber 14 (shown in FIG. 2) and first and second fluid passages 16, 18 opening as respective first and second ports 20, 22 in the hollow chamber 14 (also shown in FIG. 2). In this example, the body assembly 12 is made of first, second and third body parts 46, 48 and 52. The first part 46, which in this case can be referred to as a bottom casing, includes the passages 16 and 18, which open as the first and second ports 20, 22 along a sidewall 51 of the hollow chamber. The second part 48, which can be referred to as a middle casing, is provided with a recessed sidewall defining a cavity which encapsulates, together with the top face of the bottom casing, the hollow chamber 14. The third part 52, which in this case can be referred to as the top casing, includes a cavity for housing a source of magnetic field and a controller. Of course, other configurations are possible for the body assembly. For example, the cavity can be provided within the bottom casing instead of the middle casing, and the cavity can be closed by the bottom face of the middle casing, for forming the chamber. In alternate embodiments, the body assembly can comprise fewer or more parts.

As shown in FIG. 2, the hollow chamber 14 is provided with sidewalls 51. It is preferable that the hollow chamber 14 be formed with a rounded or curved sidewall 51a, to avoid sharp corners which create dead volumes or fluid entrapment zones. It is also preferable that the chamber 14 have a uniform cross-section, with a smooth and even inner surface, without any indentations, protrusions or interfering elements which are likely to create dead volumes and entrapments zones or regions for fluid passing through the chamber. In this embodiment, the hollow chamber has a shape reminiscent of a semi-sphere or a semi-ellipsoid. In the present embodiment, the hollow chamber 14 also includes flat bottom 51b and top 51c sidewalls. In other embodiments, however, the bottom and top sidewalls may also be curved. The first and second ports 20, 22 open along a common sidewall 51b of the hollow chamber 14, although other configurations are possible.

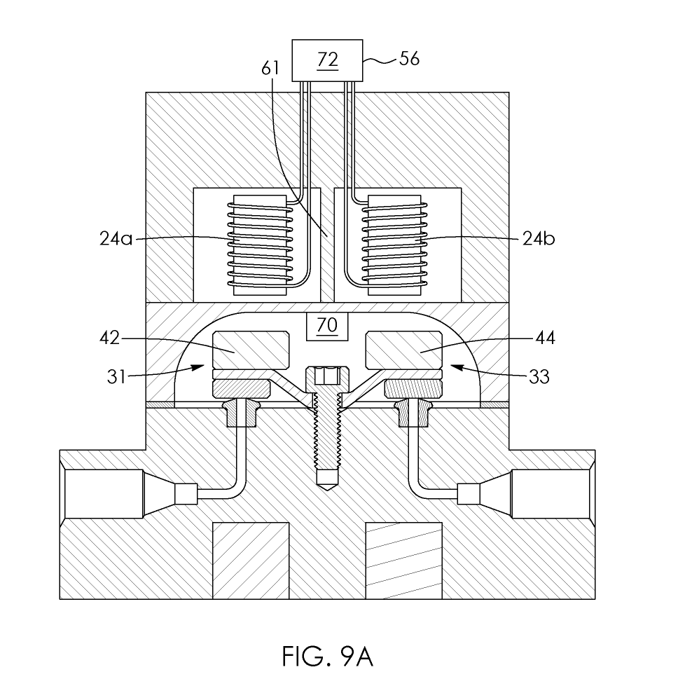

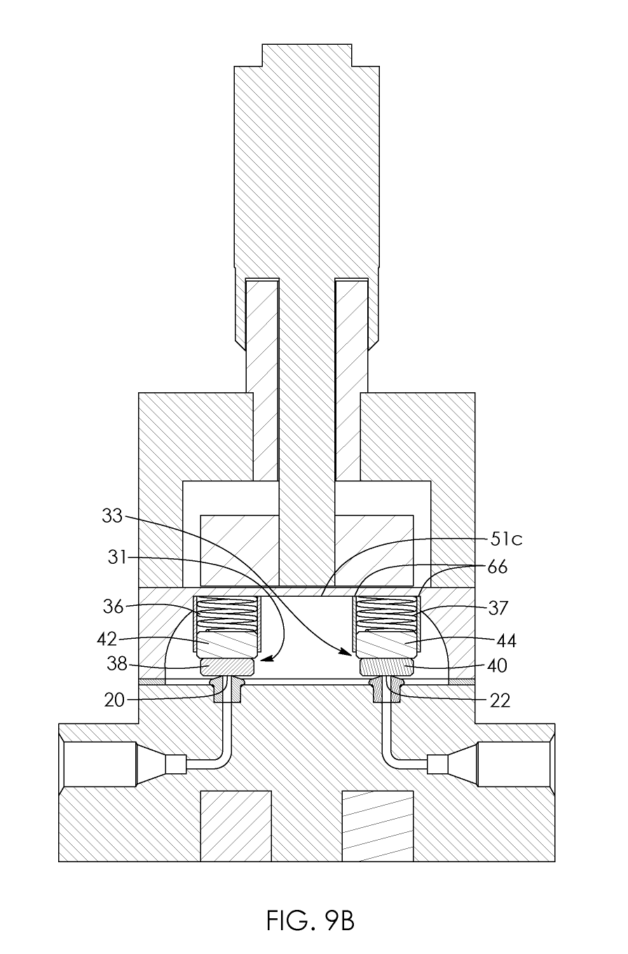

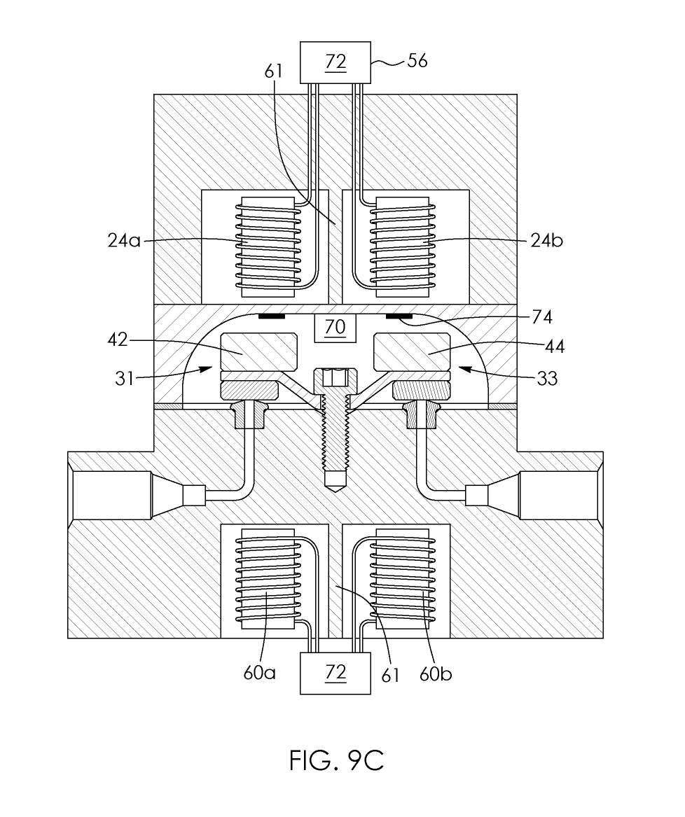

In some embodiments, the valve 10 may be provided with a pressure sensor or a plurality of sensors. As illustrated schematically in the embodiment of FIG. 9A, a pressure sensor 70 may be provided within the hollow chamber 14 for measuring the pressure of fluid within the hollow chamber 14. Of course, in other embodiments, other sensors could be located elsewhere, for example, for measuring pressure within the fluid passages 16, 18.

Referring back to FIGS. 1, 2 and 3, a non-ferrous seal 50 is provided between the bottom and middle casing for sealing the hollow chamber 14 of valve 10. The non-ferrous seal 50 can comprise non-ferrous metals such as aluminum, copper, lead, nickel, tin, titanium, zinc or mixtures thereof, or non-ferrous alloys. Alternatively, the non-ferrous seal 50 can be made of a suitable plastic material such as PVC. In the embodiment shown, the non-ferrous seal 50 is located between the first and second body parts 46, 48 and the hollow chamber 14 is defined in part by the non-ferrous seal 50. The valve 10 is also provided with a first source of magnetic field 24 for generating a magnetic field in the chamber 14. The first source of magnetic field 24 can be any type of magnet or other device capable of generating a magnetic field, such as, but not limited to, a permanent magnet or an electromagnet. Preferably, the first source of magnetic field 24 is a controllable source of magnetic field, meaning that it is possible to vary the strength of the magnetic field generated in the hollow chamber.

In the presently illustrated embodiment, the first source of magnetic field 24 is a permanent magnet provided in a cavity of the top casing 52. The cavity forms a chamber 54 with the top face of the middle casing 48. The magnetic field in the chamber 14 can be controlled or modified by moving the magnet up and down within the chamber 54. In other words, the second chamber 54 is sized such that the magnet 24 is movable therein so as to vary the distance between the magnet 24 and the hollow chamber 14. As the magnet 24 is moves away from the hollow chamber 14, the strength of the magnetic field within the chamber 14 will decrease.

In the illustrated embodiment, the first source of magnetic field 24 is a single magnet generating a single magnetic field in the chamber 14. However, in other embodiments, such as the one illustrated in FIG. 9A, the first source of magnetic field 24 may include several magnetic elements. In the embodiment of FIG. 9A the first source 24 includes first and second magnetic elements 24a and 24b. The first and second elements 24a, 24b can be configured such that they independently operate on the first and second ferromagnetic elements 42, 44 respectively. In the illustrated embodiment, the first magnetic element 24a is positioned in proximity to the first ferromagnetic element 42, while the second magnetic element 24b is positioned in proximity to the second ferromagnetic element 44. A magnetically isolating wall 61 is provided between the first and second elements 24a, 24b. The wall 61 can serve to magnetically insulate the elements 24a, 24b from one another, and to direct the magnetic field generated by each of the elements 24a, 24b into the hollow chamber. In this configuration, magnetic field generated by the first magnet 24a will have a more significant effect on the first ferromagnetic element 42 than the second ferromagnetic element 44. The first magnet 24a can therefore be said to be acting primarily on the first ferromagnetic element 42. The same can be said for the second magnet 24b in relation to the second ferromagnetic element 44.

One should understand that the two-magnet configuration is not limited to the embodiment of FIG. 9A. For example, in the embodiment of FIG. 2, the first source of magnetic field 24 could include first and second distinct permanent magnets. Additionally, in the embodiment of FIG. 9A, both the first and second elements 24a, 24b are positioned at the same distance relative to the hollow chamber. However, in other embodiments, they could be offset, such that one element is closer to the hollow chamber than the other.

An advantage of the described configurations is that the behavior of the caps can be controlled independently from one another. This means that the caps can be configured to oscillate at different frequencies and/or amplitudes when subject to a pressure from fluid entering or exiting the valve.

A further advantage of the described configurations is that the distance between the caps and their corresponding ports can be controlled precisely, thus allowing adjusting the overall flow coefficient of the valve. The magnetic field can be tuned in order to maintain the caps at a predetermined distance from their corresponding ports.

Yet another advantage of the described configurations is that the motion or oscillations of the cap can be controlled directly using the magnetic field. Therefore, even if there is very little fluid flow through the ports, the caps can be oscillated using the magnetic field in order to purge impurities from the valve. In this sense, the first and second caps can be said to be configured to oscillate relative to the first and second ports in response to a change of magnetic field in the hollow chamber.

In the embodiment of FIG. 2, the first source of magnetic field 24 is a permanent magnet. However in other embodiments, such as the one illustrated in FIGS. 9A to 9C, the first source of magnetic field 24 may include a combination of different types of magnets and magnetic materials. As illustrated in FIG. 9A, the first and second magnetic elements 24a and 24b are both electromagnets. The first source of magnetic field 24 can be controlled by varying the current flowing through the electromagnets, by varying their position relative to the hollow chamber 14, or both. Of course, in other embodiments, other combinations are possible. For example, the first magnetic element 24a could be a permanent magnet, while the second magnetic element 24b could be an electromagnet.

Preferably, the first source of magnetic field 24 is operatively coupled to a controller 56 for controlling the strength of the magnetic field generated in the hollow chamber 14. In the embodiment of FIG. 2, the controller 56 is a device which serves to vary the position of the magnet 24 relative to the hollow chamber. More specifically, the controller in the illustrated embodiment is a Vernier-type handle 56 operatively connected to the magnet 24, and threadably connected to the upper part of casing 52. The controller 56 is described as Vernier-type in that it can include any type of handle which can precisely control the position of the magnet 24. The controller 56 may include a Vernier scale, for example, and resemble the handle used in a typical micrometer. An advantage of the illustrated configuration is that the Vernier-type handle or micrometer acting as controller 56 of the valve 10, can be easily changed to an automated controller without having to disconnect the valve 10 from an analytical system to which it may be attached, and without having to expose the chamber 14 to ambient air.

In the embodiment of FIG. 2, the first source of magnetic field 24 includes a single magnetic element, and therefore the controller 56 only includes a single Vernier-type handle. In other embodiments, such as when the first source 24 includes two or more magnetic elements, the controller 56 may include a single Vernier handle to move all the magnetic elements simultaneously. The magnetic elements could be moved by the controller either at the same rate or different rates. If the magnetic elements are offset from one another, the controller can be configured to move each of the elements such that they maintain their offset, or so that their offset changes. In other embodiments, the controller may include two or more Vernier-type handles, or other controller types, in order to control each of the magnetic elements individually.

In the embodiment of FIG. 9A, the controller 56 includes an electric circuit 72, such as a microcontroller for example, capable of varying the flow of electric current in the electromagnets 24a, 24b. In this embodiment, the electromagnet is fixed in proximity to the hollow chamber. Increasing the current flowing in the electromagnet increases the strength of the magnetic field which it generates, and thus increases the strength of the magnetic field within the hollow chamber 14. The current could also be reversed in order to reverse the polarity of the electromagnets 24a, 24b. In other possible embodiments, however, the controller could include both a device to vary the position of the electromagnet and a circuit to vary the flow of electric current in the electromagnet.

The electric circuit 72 may include feedback signals in order to more precisely control the valve. For example, the electric circuit 72 can be operatively coupled to the pressure sensor 70 in order to control the electromagnets 24a, 24b according to the pressure in the chamber. The circuit 72 can also be operated according to feedback signals relating to the position of the caps 31, 33. For example, as illustrated in FIG. 9C, a capacitive sensor 74 can be placed along a sidewall in the hollow chamber in order to measure a change of capacitance as the caps 31, 33 move towards or away from the sensor 74. The capacitance can, for example, be measured between the sensor and a wire placed on the cap 31, 33. The measured capacitance can serve establish the distance of the caps 31, 33 relative to their corresponding ports. Of course, in other embodiments, the capacitive sensor could be placed in other configurations. The positions of the caps 31, 33 can also be established by measuring changes in inductance. As the caps 31, 33 move relative to their corresponding electromagnets 24a, 24b, the inductance the electromagnets will change. Therefore, the circuit 72 can be configured to measure the inductance of each of the electromagnets 24a, 24b in order to determine the position of the caps 31, 33. Using the various feedback signals, the electric circuit 72 can act as a servomechanism to precisely control the motion of the caps 31, 33 and provide automatic error correction. For example, in the embodiment of FIG. 9C, although the first and second magnets 24a, 24b act primarily on the first and second caps 31, 33 respectively, the magnetic field of the first magnet 24a may still have some effect on the second cap 33. Similarly, the second magnet 24b may have an effect on the first cap 31. Therefore, when activating the first magnet 24a to move the first cap 31, the second cap 33 may experience an undesired force, causing it to move slightly. The electric circuit 72 could compensate for this, for example by measuring the position of the second cap 33, and activating the second magnet 24b in order to counteract the undesired forces and correct the position of the second cap 33. Of course, the electric circuit 72 could be configured to correct for other types of errors relating to the position of the caps or the flow of fluid through the valve.

In other possible embodiments, the controller 56 can also be an automated controller. This means that the controller can be configured to receive remote input signals for remotely controlling the magnetic field. The controller may include a motor or an actuator, for example, which can vary the position of the magnet 24, or could be a microcontroller 72. The automated controller may also modulate the electric signal sent to an electromagnet.

Referring again to FIG. 2, the first part 46, or bottom casing, which is part of the body assembly 12, is provided with first and second connectors 26, 28 in fluid communication with the fluid passages 16, 18. The connectors are shaped, configured and sized to connect or receive tubes or capillaries through which the fluid will flow in and out of the valve. The fluid passages open on the outer surface of the body 12 as ports 30, 32. In different variants of the valve, the valve 10 can be a bidirectional valve. The first and second connectors 26, 28 are interchangeable as inlet or outlet connectors, and the first and second body ports 30, 32 are interchangeable as inlet or outlet ports. In this particular embodiment, the ports are located side by side. The ports 20, 22 open on the top face of the bottom casing in the same plane, but other configurations are possible.

Still referring to FIGS. 1, 2 and 3, and best shown in FIG. 2, a valve assembly 34 is provided within the chamber 14. The valve assembly 34 includes first and second caps 31, 33 resiliently affixed to the body assembly 12. In the illustrated embodiment, the caps are affixed via first and second resilient or flexible elements 36, 37, which are operatively connected to the body assembly 12. The resilient elements 36, 37 are connected to the bottom case 46 with a screw 62. It should be understood that the screw 62 may be substituted for another type of suitable fastener known in the art, such as, but not limited to, a bolt, a clamp, a pin, by soldering, or a combination thereof.

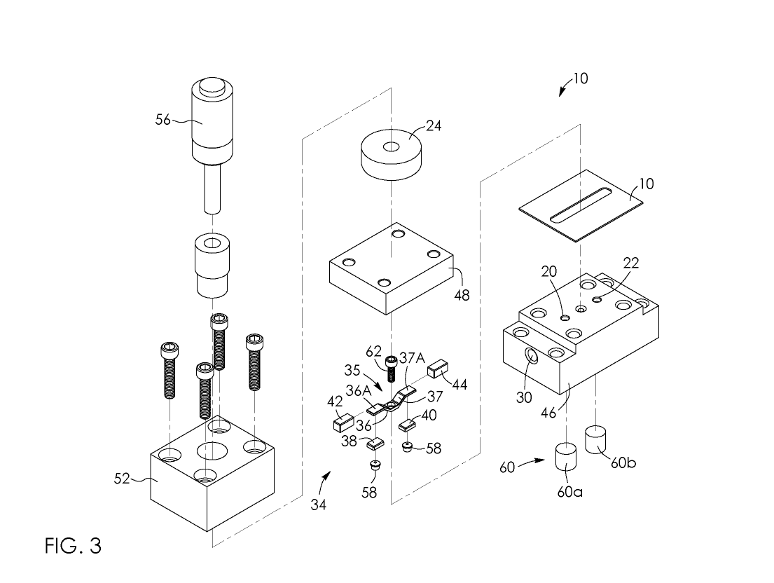

In this embodiment of the valve, and as best shown in FIG. 3, the resilient elements 36, 37 are integrally formed from the same piece, i.e. they are part of the same V-shaped strip 35. The resilient elements 36, 37 can be made of metal or plastic, for example. The strip 35 has a central portion from which two flexible and preferably resilient arms or wings extend in opposite directions. The arms form the resilient elements 36, 37, and terminate in a first end 36A and a second end 37A.

Preferably, the resilient elements 36, 37 are flexible, such that caps 31, 33 are able to move or oscillate relative to the ports 20, 22, under the action of a magnetic force present in the chamber and/or according to the flow of fluid entering or exiting the valve. In other words, the arms or wings of the resilient elements 36, 37 are preferably flexible, even if only slightly, so as to be able to flex, move or bend when the caps 31, 33 are attracted or repelled by the magnet and/or when fluid is injected within the chamber with sufficient pressure. Of course, other embodiments of the resilient elements 36, 37 are possible. For example, the valve assembly 34 can include two distinct, resilient elements. Optionally, the resilient elements 36, 37 could be pendulum springs.

In another possible embodiment, as illustrated in FIG. 9B, the first and second resilient elements can consist of springs 36, 37 affixed to a sidewall 51 of the chamber 14, with the caps 31, 33 located at both of the free ends of the resilient elements 36, 37, in alignment with the ports. In this case the sidewall is the “ceiling” 51c of the chamber, or the top sidewall, opposed to and facing the ports. A guide can be used to guide the movement of the caps 31, 33 such that they are always aligned with the ports 20, 22. The guide can be a sleeve 66, for example, which can serve to guide the movement of the first and second springs 36, 37, respectively.

Referring to FIGS. 1, 2 and 3, the caps 31, 33 include first and second seats or cushions 38, 40 provided on the respective ends 36A, 37A of the resilient elements. The cushions 38, 40 are preferably respectively facing or aligned with the first and second ports 20, 22, such that they can provide a sealing surface for contact therewith. The cushions 38, 40 are preferably operatively connected to first and second ferromagnetic elements 42, 44 and/or are respectively directly attached to the first and second ends 36A, 37A. Preferably, the cushions 38, 40 are soft seats made of a slightly compressible material, such as a polymeric material.

The ports 20, 22 may be provided with perforated port caps 58 so as to provide an improved sealing surface for the cushions 38, 40. In the illustrated embodiment, the port caps 58 have a mushroom-like shape which provides contact points between the cushions 38, 40 and the ports 20, 22 above the top face of the seal 50, thereby providing an efficient seal when the cushions 38, 40 are in the closed position. It is possible that the port caps 58 can have different shapes.

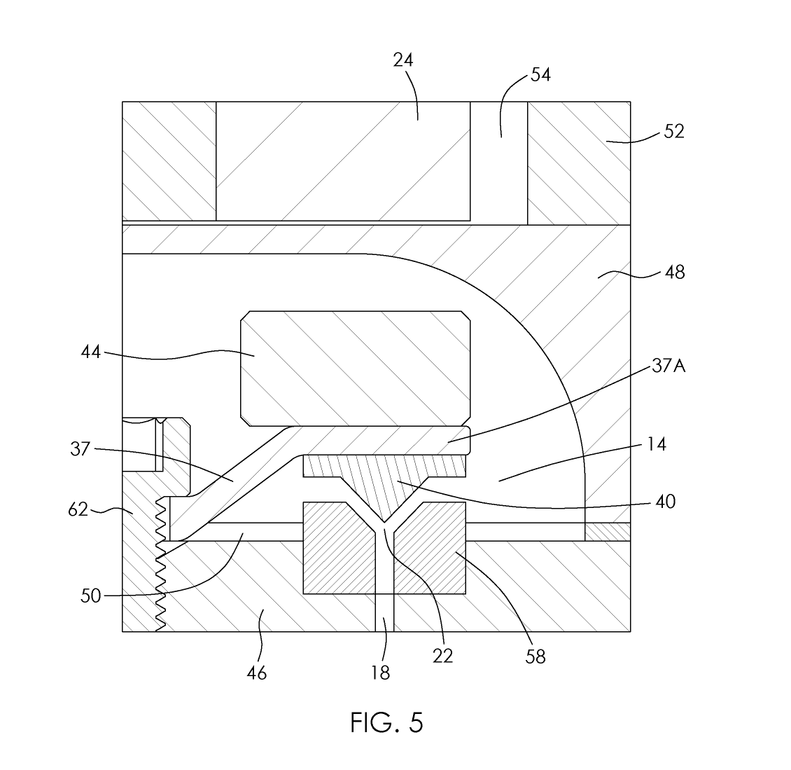

With reference now to FIG. 5, the cushions 38, 40 may be complementary in shape to their respective ports 20, 22 and/or port caps 58. For example, as illustrated in the present embodiments, the cushions 38, 40 can have a conical shape with a pointed tip. Reciprocally, the port caps 58 can be truncated, and be provided with a mating conical cavity or indentation, such that the cushions 38, 40 can be nested within the port caps 58 when the valve is in a closed position. Such a configuration may help regulate the flow, pressure and velocity of the fluid in the hollow chamber 14.

Referring back to FIGS. 1, 2 and 3, the valve 10 may be provided with a second source of magnetic field 60 in order to strengthen or counteract the effects of the first source of magnetic field 24. The provision of a second source may provide additional advantages. In the illustrated embodiment, the second source of magnetic field includes two permanent magnets 60a and 60b. In other embodiments, however, the second source of magnetic field could be a single magnet. As illustrated, the second source of magnetic field 60 is located opposite the first source 24 of magnetic field, i.e. the first and second sources of magnetic field are separated via the hollow chamber. In this configuration, depending on its polarity, the second source of magnetic field 60 can serve to partially counteract or strengthen the effects of the magnet 24, to further vary or control the flow coefficient (Cv) of the valve 10. In the illustrated embodiment, the second source of magnetic field 60 is located in the bottom casing 46, but this second source of magnetic field 60 can be located at any suitable location which allows the partial counteraction or reinforcement of the effect of the first source of magnetic field within the hollow chamber 14.

Using a second source 60 of magnetic field in conjunction with a first source 24 which can induce a higher or lower magnetic field will have the effect of varying the flow coefficient of the valve. In the illustrated embodiment, the second source of magnetic field 60 is disposed near the exterior of the body assembly 12, and is thus easily accessible for removal and/or replacement. The second source 60 can be removably affixed to the body by several means. For example, it can be affixed using a screw, through a press-fit, or simply held in place by magnetic attraction. Since the second source 60 is replaceable and easily accessible, the variation of flow coefficient can advantageously be achieved without taking the valve 10 offline and/or without disconnecting the valve from the analytical circuit.

In other embodiments, the second source of magnetic field 60 can be subject to similar variations/combinations as the first source 24. As illustrated in FIG. 9C, the second source 60 may include first and second magnetic elements 60a, 60b which can act primarily on the first or second ferromagnetic elements 42, 44, for example by being separated by a magnetically isolating wall 61 to insulate or guide the magnetic field, or by being positioned in proximity to one of the caps. The magnetic elements 60a, 60b could be permanent magnets or could be electromagnets. The polarity of the magnetic elements 60a, 60b could be set according to the desired function of the valve. Additionally, the second source of magnetic field 60 could be a controllable source of magnetic field, meaning that the second source 60 can be controlled in a similar manner as the first source 24 in order to vary the strength of the field it generates within the hollow chamber 14. In the illustrated embodiment, the electromagnets 60a, 60b are controlled via an electric circuit 72, but they could also be controlled using a Vernier-type handle. The electric circuit 72 may be part of the same circuit which controls the first source 24, or could be a separate circuit.

Although the embodiments of the invention were described with reference to first and second sources of magnetic field, one skilled in the art will understand that the scope of the invention may include additional sources of magnetic field arranged in other positions relative to the hollow chamber in order to control the operating characteristics of the valve. Additionally, the polarity of each of the magnets in the first and second sources of magnetic field can be varied in order to attain desired results, such as for controlling the flow of fluid in the chamber by independently controlling the distance of the first and second caps from the corresponding first and second ports, or for oscillating the first and second caps relative to the first and second caps.

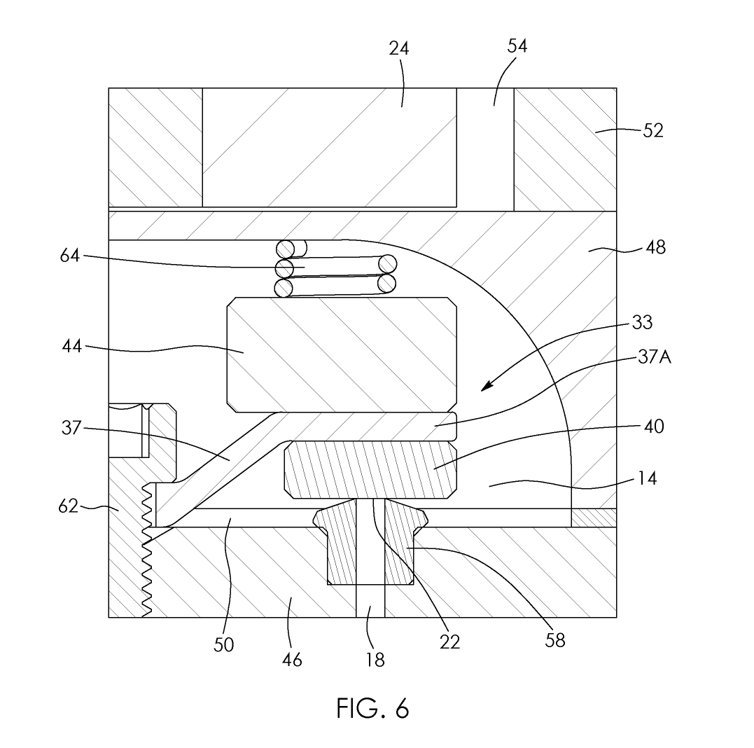

Now referring to FIG. 6, the valve assembly may be provided with optional biasing elements 64 located between the first or second caps 31, 33, and the body assembly 12. In the presently illustrated embodiment, the biasing elements are particularly positioned between the first or second ferromagnetic elements 42, 44 and an edge of the hollow chamber 14. Each biasing element 64 biases the first or second caps 31, 33 towards the corresponding first or second ports 20, 22. The biasing elements 64 allow for a mechanical counterbalance to the magnetic field in the hollow chamber 14. The flow coefficient of the valve can thus be selected depending on the configuration or strength of the biasing elements 64. In the exemplary embodiment shown, the biasing element 64 is a spring, but other types of resilient elements could also be used, such as a compressible polymeric ring for example.

The biasing elements 64 may serve to bias both caps 31, 33 in the same manner. However, in other embodiments, the biasing elements 64 could provide a different bias to each of the caps 31, 33. In this manner, the caps 31, 33 could be configured so as to oscillate at different frequencies, and thus allow the hollow chamber 14 to be purged more effectively during operation of the valve 10.

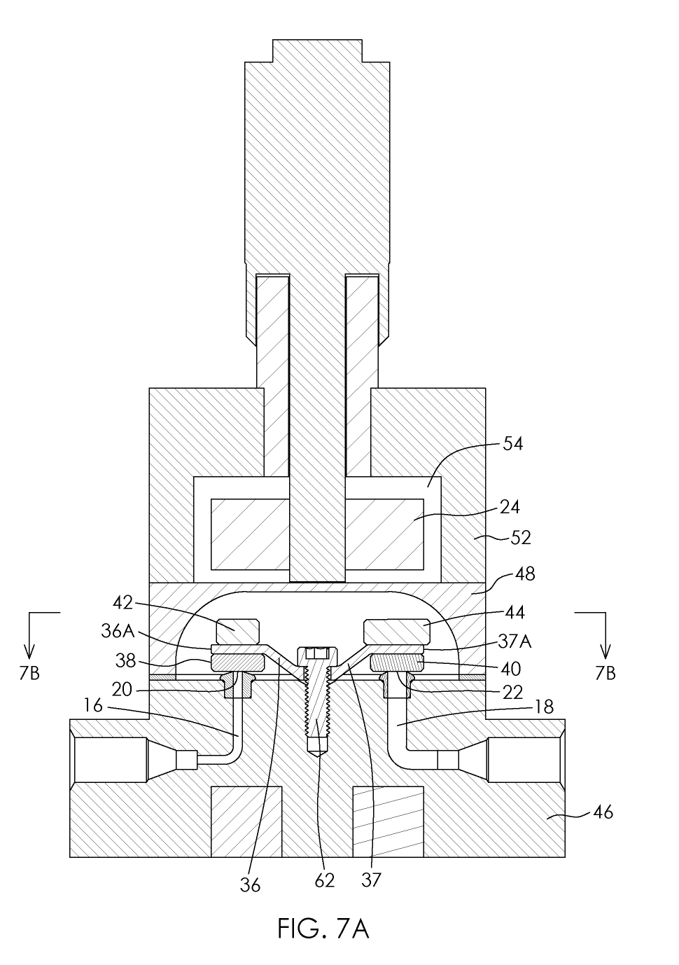

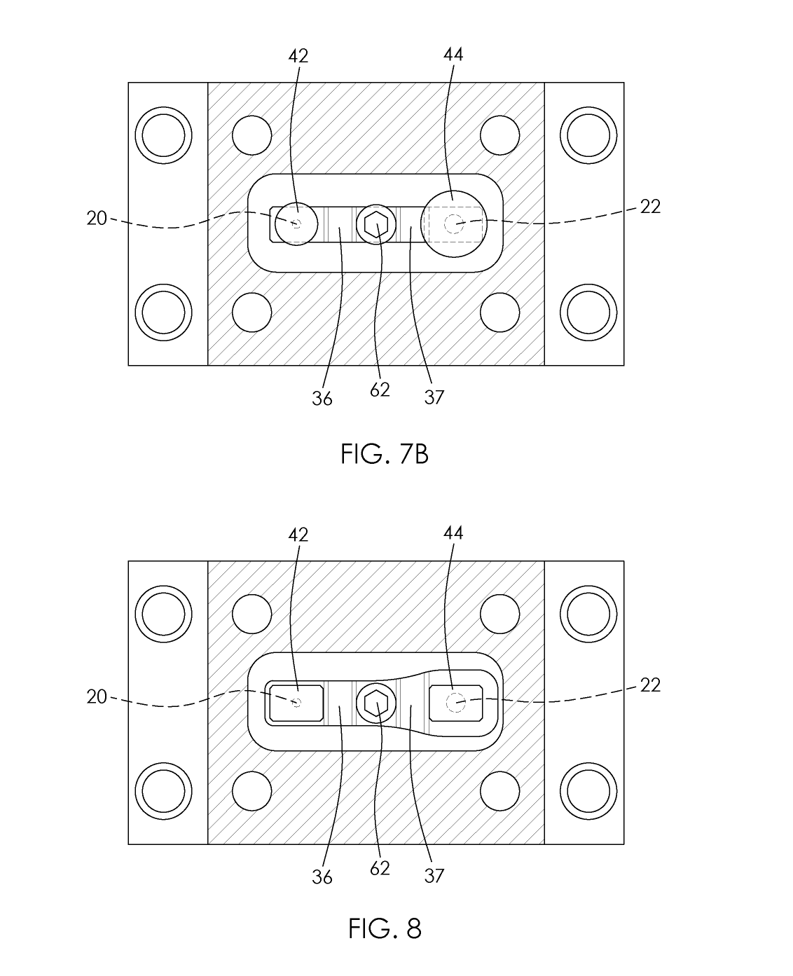

Now referring to FIGS. 7A and 7B, another magnetic metering valve 10 is shown according to an embodiment of the invention. In this embodiment, the second port 22 is an outlet port having a larger diameter than the first port 20, which is an inlet port. Accordingly, the sealing surface of cushion 38 is smaller than the second sealing surface of cushion 40. In this example, the first ferromagnetic element 42 located on top of the first end 36A is smaller and/or less massive than the second ferromagnetic element 44 located on top of the second end 37A. Therefore, the area of the second ferromagnetic element 44 covering the second end 37A is wider and oversized compared to the area of the first ferromagnetic element 42 covering the first end 36A. Providing the first passage 16 and port 20 with diameters smaller than the respective diameters of the second passage 18 and ports 22 will increase the pressure and velocity at which the fluid enters the chambers, which will increase the amplitude of the oscillations of the resilient elements 36, 37, further increasing the efficiency of the purging effect and static dilution within the chamber 14.

One skilled in the art will understand that varying the mass of the caps 31, 33, for example by varying the mass of the ferromagnetic elements 42, 44, may affect the oscillating characteristics of the caps 31, 33 during operation. For example, if a cap is more massive, is may oscillate more slowly or with a larger amplitude than a less massive cap. Additionally, one will understand that the effect of the sources of magnetic field on the caps 31, 33 is dependent on the magnetic properties of the ferromagnetic elements 42, 44. If the sources of magnetic field affect one cap more than the other, the caps may oscillate at different frequencies. As such, it should be understood that the caps 31, 33 could be configured to oscillate at different frequencies or with different amplitudes by providing one cap which is heavier/more massive than the other, and/or by providing one ferromagnetic element with different magnetic properties than the other.

Now referring to FIG. 8, another embodiment of a magnetic metering valve 10 according to the invention is shown. In this embodiment, the resilient element 37 located proximate to the outlet port 22 is wider and oversized compared to the resilient element 36 located proximate to the inlet port 20. Furthermore, the wider resilient element 37 can have an ovoid shape. The ovoid shape acts as a foil, dispersing fluid entering the chamber toward the second port 22. In this embodiment, the ferromagnetic parts 42, 44, are of similar size. Of course, ferromagnetic parts 42, 44 may also have a similar configuration as described above for FIGS. 7A and 7B. In this embodiment, the first passage 16 and port 20 have smaller respective diameters than the respective diameters of the second passage 18 and ports 22.

One skilled in the art will understand that the size and configuration of the resilient elements 36, 37 may have an effect on the oscillating frequency of the caps 31, 33 during operation. For example, by varying the size or stiffness of the resilient elements 36, 37, the modulus of elasticity of each resilient element 36, 37 can be varied. Accordingly, the caps 31, 33 could be configured to oscillate at different frequencies by providing resilient elements with different moduli of elasticity.

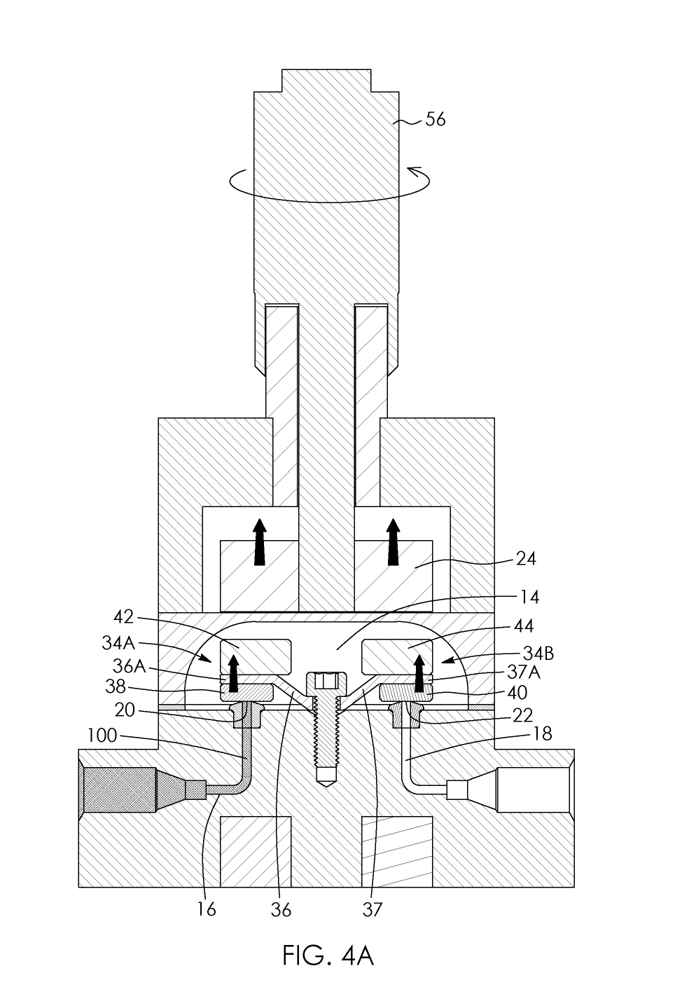

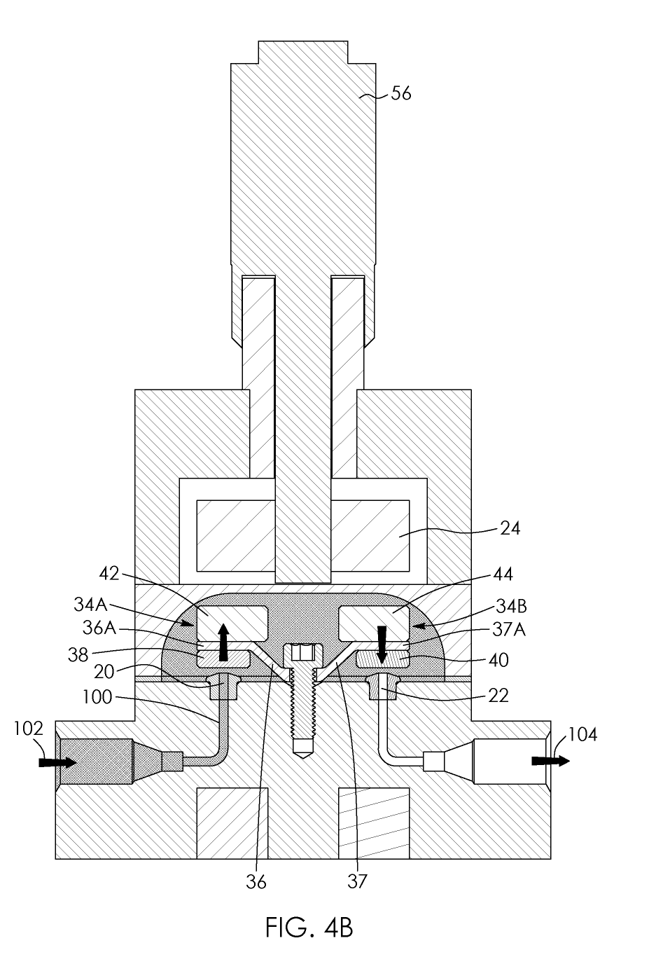

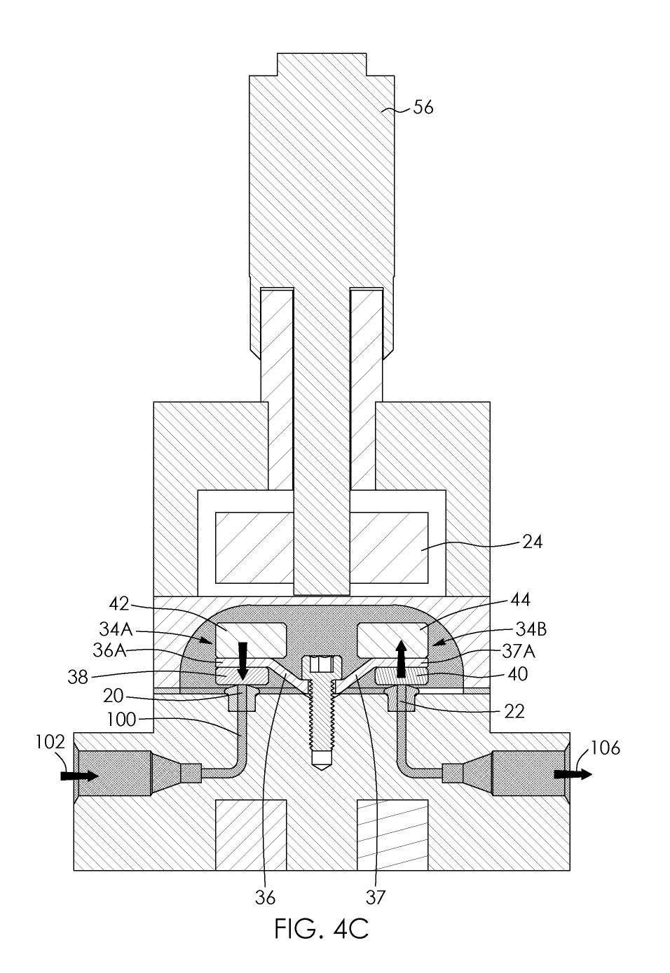

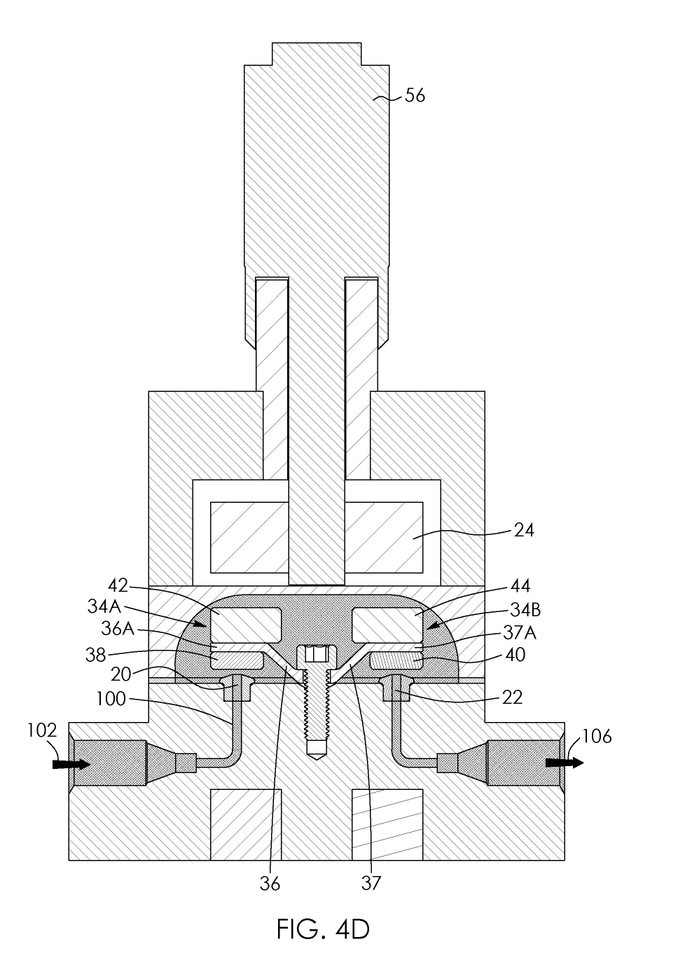

Now referring to FIGS. 4A, 4B and 4C, the method for purging the magnetic metering valve 10 will be explained.

In FIG. 4A, the valve 10 is shown in a closed position. The magnet 14 is positioned such that the first and the second parts 34A, 34B of the valve assembly are both in a closed position (each one of the first and second seats 38, 40 obstruct or close the respective ports 20, 22). Fluid 100 is injected in the first fluid passage 16 at a pressure Pin and a velocity Vin. The fluid 100 is obstructed by the first cushion 38 and does not enter the hollow chamber 14, which is at a pressure P0. The controller 56 is actuated so as to vary the magnetic field in the hollow chamber 14. In the present embodiment, the source of magnetic field is moved towards the hollow chamber in order to increase the magnetic field. In other embodiments, however, the field could be varied by increasing the flow of electric current to an electromagnet, for example. In yet other embodiments, the polarity of the magnets could be reversed, and opening the valve can be accomplished by moving the first source of magnetic field away from the hollow chamber. As a result of varying the magnetic field in the hollow chamber 14, both parts 34A, 34B of the valve assembly 34 move away (in this case upwardly), from the respective first and second ports 20, 22, thereby opening the valve 10. The first part 34A of the valve assembly includes the first ferromagnetic element 42, the first resilient element 36 and the first cushion 38. The second part 34B of the valve assembly includes the second ferromagnetic element 44, the second resilient element 37 and the second cushion 40.

Now referring to FIG. 4B, the valve 10 is in an open position and the fluid 100 fills the hollow chamber 14. As the fluid 100 is filling the hollow chamber 14, the pressure in the hollow chamber 14 increases from P0 to P1. The inlet flow 102 of fluid entering the valve exerts an additional force on the first part 34A of the valve assembly 34, moving and pushing the first part 34A further away from the first port 20. At this step, a transitional outlet flow 104 may be flowing out of the valve 10 from the second fluid passage 18. Since there is more space, i.e. less restriction, between the port 20 and cushion 38, the force exerted by the fluid entering the chamber on the cushion 38 will decrease, which will in turn cause the cushion 38 to move back closer to the port 20, i.e. the cushion 38 will move downwardly, toward the port 20 (as shown on the left hand side of FIG. 4C). On the other side of the valve element 34, when fluid 100 exits through port 22, part 34B is drawn toward port 22 by a suction force, as shown in FIG. 4B. In FIG. 4C, since there is less fluid injected in the chamber, the pressure in the chamber decreases to P2, with P0≦P2≦P1, and therefore less fluid exits through port 22, since the pressure inside the chamber has decreased from P1 to P2. The pressure drop in turn reduces the suction force pulling part 34B toward port 22, and thereby part 34B moves away from port 22. Since the fluid 100 is injected continuously in the chamber 14, the oscillating movement of the first part 34A will continue for several oscillations depending on the initial pressure change, which will purge impurities and/or the fluid which was initially present in the chamber through port 22. The structure and configuration of the metering valve thereby allows for an efficient purge, or static dilution, of the chamber at the beginning of any fluid injection within the valve.

Depending on the valve configuration, the oscillating movement can slowly decay to arrive at a steady state, or can be continuously reinitiated to maintain purging capabilities during operation of the valve. For example, by providing a single continuous input pressure or rate of fluid flow, the parts (i.e. caps) could oscillate during a transient period, before eventually reaching a steady state where they remain at a fixed position away from the ports, allowing for a consistent flow of fluid with a steady pressure in the chamber. In another embodiment, the input pressure or the rate of fluid flow could be varied. In such cases, the parts could be maintained in a transient state, causing them to oscillate continuously or for a longer period of time. Similarly, the magnetic field acting on one of the two caps 31, 33 could be varied in order to oscillate the parts.

The oscillating motion of the resilient elements 36, 37 promotes a variation of the pressure in the hollow chamber 14, which purges the chamber without any external purging system. When the first part 34A of the valve assembly 34 is restricting the first port 20 and the second part 34B of the valve assembly 34 is away from the second port 22, the pressure in the chamber decreases. Similarly, when the first part 34A of the valve assembly 34 is away from the first port 20 and the second part 34B of the valve assembly 34 is restricting the second port 22, the pressure in the chamber increases. Such pressure variations therefore allow for an efficient purge of the valve 10 and minimize “dead volume” (i.e. undesired fluid stagnating in the chamber). It is understood that when the pressure increases in the hollow chamber 14, the velocity of the fluid in the hollow chamber 14 decreases and that when the pressure decreases in the hollow chamber 14, the velocity of the fluid in the hollow chamber 14 increases.

To purge the valve 10 more effectively, it may be desirable to promote turbulence and more significant variations of pressure within the hollow chamber 14. As such, the parts can be operated to oscillate at different frequencies and at different amplitudes. Additionally, the parts could be operated to oscillate in phase or out of phase with one another. As described above, such operation can be achieved through varying different properties of the parts, for example by making one part heavier, more elastic, more voluminous, or more susceptible to a magnetic field than the other part, or by controlling one of the parts individually by an additional source of magnetic field.

Depending on the configuration of the valve 10 and of the different components, the valve 10 may operate at various pressure ranges. For example, in some configurations, the valve may operate at pressures lower than 150 psi. For example, in other configurations, the valve may operate between 50 and 200 psi, or between 200 and 1000 psi, or between 1000 and 2000 psi, or again between 2000 and 5000 psi, or again above 5000 psi.

An advantage of the present invention is that it allows purging the valve 10 while operating at many different pressures or rate of fluid flow. When there is a significant amount of input pressure and fluid flow, for example around 100 psi, the pressure of the fluid alone may be sufficient to oscillate the first and second caps so as to purge the chamber of impurities. However, when the input pressure is low, for example around 1 or 2 psi, the fluid alone may not be enough to cause significant oscillations of the caps in order to purge the chamber. In such cases, the present invention allows for a static purge to be performed. The sources of magnetic field can be operated so as to oscillate the caps via the magnetic field. For example, in the embodiment of FIG. 9A, the first and second electromagnets 24a, 24b can be operated by the electric circuit 72 to generate oscillating magnetic fields in the hollow chamber 14 which in turn cause the desired oscillations of the caps 31, 33. The hollow chamber 14 can thereby be purged without relying on the pressure of the fluid.

At the end of the purging process, as shown in FIG. 4D, the valve is in an open position and has been purged of impurities. The oscillating motion has stopped and a stabilized steady state and/or precise outlet flow 106 is obtained. In this phase the metering valve can be operated in order to control the rate of fluid flow from the valve. For example, the magnetic field can be varied in order to maintain one or both of the caps a fixed distance away from their corresponding ports. The distance between the caps and their corresponding ports determines the rate at which fluid can flow through the ports, and thus the net flow of fluid through the valve.

Advantageously, the present invention allows for the rate of fluid flow to be controlled precisely. In an embodiment such as the one illustrated in FIG. 9A, the caps can be controlled individually in order to adjust the rate of fluid flow from the valve. According to a method of operating the valve, one of caps can be fixed and positioned at a first distance from its corresponding port, while the other cap can be adjusted in order to vary the net flow of fluid, by positioning this other cap at another distance from its corresponding port. The method first involves providing a magnetic metering valve such as the one illustrated in FIG. 9A. The valve is configured such that the first cap 31 covers the input port of the valve, while the second cap 33 covers the output port of the valve. The first cap 31 is operated to define a maximum rate of fluid flow entering the valve. This means, for example, that the magnetic field generated by the first electromagnet 24a can be tuned so that the first cap 31 is maintained at a fixed distance away from the first port. The distance between the first cap and port defines the maximum rate of fluid flow which can enter the valve. Next, the second cap 32 is operated to vary the flow of fluid exiting the valve. This means, for example, that the magnetic field generated by the second electromagnet 24b can be varied so that the distance between the second cap 33 and the second port is varied. Since the rate of fluid exiting the valve cannot exceed the rate of fluid entering the valve, the second cap 33 can vary the net rate of fluid flow exiting the valve between 0 (i.e. when the second cap 33 is in direct contact with the port) and the maximum rate which was set by the first cap 31 (i.e. when the distance between the second cap 33 and second port is equal to or greater than the distance between the first cap 31 and first port, assuming both ports have the same diameter). Advantageously, this method allows for the metering valve to be operated within a fixed range. Furthermore, since the first cap 31 is controllable, the range can be subsequently adjusted if a different maximum flow rate is desired.

In the embodiment of FIG. 9A, the electromagnets 24a, 24b are coupled to a controller 56 which includes an electric circuit or microcontroller 72 for controlling the flow of electric current to the electromagnets 24a, 24b. The method may therefore be performed by the microcontroller 72. The method may also involve the step of receiving, on the microcontroller 72, a feedback signal from the pressure sensor 70 indicative of the pressure within the hollow chamber. The microcontroller 72 can subsequently adjust the rate of fluid flow responsive to the signal, for example to attain a predetermined pressure within the valve.

As can be appreciated, the present method of controlling a magnetic metering valve is not limited to the embodiment of FIG. 9A. The same or similar methods can be used with other embodiments, for example where there is a second controllable source of magnetic field, such as in FIG. 9C, or where the magnetic field is controlled mechanically, such as in FIG. 2. The method can also apply to valves with different internal configurations, for example where the caps include a biasing element, such as in FIG. 6, or where the resilient elements are springs, such as in FIG. 9B. It should be appreciated that features of one of the above described embodiments can be combined with the other embodiments or alternatives thereof. For example, any combination of first and/or second sources of magnetic field can be combined with any internal configuration of the valve, caps, resilient elements, and with any controller type.

Moreover, although the embodiments of the valve and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the valve, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments therefore are to be considered in all respects as illustrative and not restrictive, and the invention is not to be limited to the details given herein. Accordingly, while the specific embodiments have been illustrated and described, numerous modifications come to mind without significantly departing from the spirit of the invention. The scope of the invention is therefore intended to be limited solely by the scope of the appended claims.

1. A magnetic metering valve, comprising:
a body assembly provided with a hollow chamber,
first and second fluid passages extending in the body and opening as first and second ports in the hollow chamber for circulating a fluid from the first fluid passage to the second fluid passage via the hollow chamber;
a first controllable source of magnetic field operable to generate a first magnetic field in the hollow chamber;
a valve assembly provided in the hollow chamber and comprising first and second caps associated with the respective first and second ports for interrupting or controlling a flow of fluid in the hollow chamber, the first and second caps being resiliently affixed to the body assembly to oscillate relative to the first and second ports, the first and second caps comprising respective first and second ferromagnetic elements to interrupt or control a flow of the fluid through the first and second ports responsive to the magnetic field in the hollow chamber.

2. The magnetic metering valve according to claim 1, wherein the body assembly comprises top, middle, and bottom casings, the middle casing being disposed in between the top and bottom casings, the top casing comprising a cavity configured to house the first source of magnetic field, the middle casing comprising a recessed sidewall defining a cavity, and the bottom casing sealing the cavity in the middle casing, thereby defining the hollow chamber.

3. The magnetic metering valve according to claim 2, further comprising a non-ferrous seal provided between the middle and bottom casings for sealing the hollow chamber.

4. (canceled)

5. The magnetic metering valve according to claim 1, wherein the hollow chamber comprises rounded sidewalls.

6. (canceled)

7. The magnetic metering valve according to claim 1, wherein the first controllable source of magnetic field comprises a permanent magnet operatively connected to a controller, the controller being operable to control the first controllable source of magnetic field by changing a position of the permanent magnet relative to the hollow chamber.

8. The magnetic metering valve according to claim 7, wherein the controller comprises a Vernier-type handle.

9. (canceled)

10. (canceled)

11. (canceled)

12. The magnetic metering valve according to claim 1, further comprising a second source of magnetic field positioned opposite the first controllable source of magnetic field and separated therefrom by the hollow chamber, the second source of magnetic field being configured to generate a second magnetic field in the hollow chamber to reinforce or counteract the first magnetic field.

13. The magnetic metering valve according to claim 1, wherein the first and second caps are resiliently affixed to the body via first and second resilient arms connected to the body assembly via a fastening mechanism, further wherein a portion of the first resilient arm disposed above the first port is wider than a corresponding portion of the second resilient arm disposed above the second port.

14. (canceled)

15. (canceled)

16. (canceled)

17. The magnetic metering valve according to claim 1, wherein the first and second caps are resiliently affixed to the body assembly via first and second resilient elements, and wherein a modulus of elasticity of one of the first and second resilient elements is greater than a modulus of elasticity of the other one of the first and second resilient elements.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. The magnetic metering valve according to claim 1, wherein the first and second caps comprise first and second cushions facing the first and second ports creating sealing surfaces when the first and second cushions respectively contact the first and second ports.

31. (canceled)

32. The magnetic metering valve according to claim 30, wherein the first and second ports comprise first and second perforated port caps configured to act as contact points for the first and second cushions, respectively.

33. The magnetic metering valve according to claim 32, wherein the cushions are complementary in shape to their respective perforated port caps, the cushions comprising protrusions and the perforated port caps comprising complementary indentations.

34. (canceled)

35. The magnetic metering valve according to claim 1, wherein one of the first and second ports has an opening diameter greater than that of the other one of the first and second ports, thereby allowing a greater rate of fluid flow through said one of the first and second ports.

36. The magnetic metering valve according to claim 1, wherein the first and second ferromagnetic elements have different magnetic properties, thereby allowing the first source of magnetic field to have a different effect on the first and second ferromagnetic elements.

37. (canceled)

38. (canceled)

39. (canceled)

40. (canceled)

41. (canceled)

42. A method of purging impurities in a magnetic metering valve, the method comprising the steps of:
a) providing the magnetic metering valve including a body assembly provided with a hollow chamber, first and second fluid passages extending in the body and opening as first and second ports in the hollow chamber, and first and second caps adapted to oscillate relative to said first and second ports, the first and second caps comprising respective first and second ferromagnetic elements;
b) generating a first magnetic field in the hollow chamber acting on the first and second ferromagnetic elements, thereby moving the first and second caps away from the first and second ports; and
c) injecting a fluid in the hollow chamber through the first port, thereby changing a fluid pressure in the hollow chamber, causing an oscillation of the first and second caps relative to their respective first and second ports, and purging impurities through the second port.

43. The method according to claim 42, further comprising the step of varying the strength of the magnetic field in the hollow chamber in order to control a rate of fluid flow through the magnetic metering valve.

44. The method according to claim 42, further comprising the step of generating a second magnetic field in the hollow chamber to control the effect of the first magnetic field acting on the first and second ferromagnetic elements.

45. The method according to claim 42, further comprising the step of varying a rate of fluid flow through the first port to change the fluid pressure in the hollow chamber.

46. The method according to claim 42, wherein step b) comprises moving a permanent magnet relative to the hollow chamber in order to vary the strength of the first magnetic field generated within the hollow chamber.

47. (canceled)

48. (canceled)

49. (canceled)

50. (canceled)

51. A method of operating a magnetic metering valve, the method comprising the steps of:
a) providing the magnetic metering valve including a body assembly provided with a hollow chamber, first and second fluid passages extending in the body and opening as first and second ports in the hollow chamber, and first and second caps adapted to oscillate relative to said first and second ports, the first and second caps comprising respective first and second ferromagnetic elements;
b) operating the first cap to define a maximum rate of fluid flow entering the valve through the first port; and
c) operating the second cap to vary a rate of fluid flow exiting the valve through the second port.

52. (canceled)
